(19) United States
(12) Patent Application Publication
(10) Pub. No.: US 2015/0045023 A1
(43) Pub. Date: Feb. 12, 2015

(54) METHODS AND APPARATUS FOR IMPROVED MEASUREMENTS IN WIRELESS COMMUNICATION SYSTEMS

(71) Applicant: QUALCOMM Incorporated, San Diego, CA (US)

(72) Inventors: Zachary David Rattner, San Diego, CA (US); Yi Su, San Jose, CA (US); Mohit Narula, San Diego, CA (US); Mayank Maheshwari, San Diego, CA (US)

(73) Assignee: QUALCOMM Incorporated, San Diego, CA (US)

(21) Appl. No.: 14/230,585

(22) Filed: Mar. 31, 2014

Related U.S. Application Data
(60) Provisional application No. 61/863,854, filed on Aug. 8, 2013.

(51) Int. Cl. H04W 48/16

(52) U.S. Cl. CPC H04W 48/16
USPC 455/434

(57) ABSTRACT

Methods and apparatus for communication comprise storing a first portion of a set of frequencies in a frequency measurement list, wherein the first portion of the set of frequencies includes a first sequence of one or more frequencies. The methods and apparatus further comprise storing a second portion of the set of frequencies in a frequency waitlist when a maximum frequency measurement list size meets or exceeds a maximum frequency measurement list size threshold value, wherein the second portion of the set of frequencies includes a second sequence of one or more frequencies. Moreover, the methods and apparatus comprise performing a communication procedure based on one or more frequencies stored in one or both of the frequency measurement list and the frequency waitlist.

### CLAIM OF PRIORITY UNDER 35 U.S.C. §119

The present application for patent claims priority to Provisional Application No. 61/863,854 entitled “METHODS AND APPARATUS FOR IMPROVED MEASUREMENTS IN WIRELESS COMMUNICATION SYSTEMS” filed Aug. 8, 2013, and assigned to the assignee hereof and hereby expressly incorporated by reference herein.

### BACKGROUND

Aspects of the present disclosure relate generally to wireless communication systems, and more particularly, to improved measurement management in wireless communication systems.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, underutilization of available communication resources, particularly measurement resources for handover, reselection and/or redirection may lead to degradations in wireless communication. Even more, the foregoing resource underutilization inhibits user equipments and/or wireless devices from achieving higher wireless communication quality. Thus, improvements in measurement management are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of communication comprises storing a first portion of a set of frequencies in a frequency measurement list, wherein the first portion of the set of frequencies includes a first sequence of one or more frequencies. Moreover, the method comprises storing a second portion of the set of frequencies in a frequency waitlist when a maximum frequency measurement list size meets or exceeds a maximum frequency measurement list size threshold value, wherein the second portion of the set of frequencies includes a second sequence of one or more frequencies. The method further comprises performing a communication procedure based on one or more frequencies stored in one or both of the frequency measurement list and the frequency waitlist.

In another aspect, an apparatus for communication comprises means for storing a first portion of a set of frequencies in a frequency measurement list, wherein the first portion of the set of frequencies includes a first sequence of one or more frequencies. Moreover, the apparatus comprises means for storing a second portion of the set of frequencies in a frequency waitlist when a maximum frequency measurement list size meets or exceeds a maximum frequency measurement list size threshold value, wherein the second portion of the set of frequencies includes a second sequence of one or more frequencies. The apparatus further comprises performing a communication procedure based on one or more frequencies stored in one or both of the frequency measurement list and the frequency waitlist.

In a further aspect, a memory storing executable instructions and a processor in communication with the memory, wherein the processor is configured to execute the instructions to store a first portion of a set of frequencies in a frequency measurement list, wherein the first portion of the set of frequencies includes a first sequence of one or more frequencies. Moreover, the processor is configured to execute the instructions to store a second portion of the set of frequencies in a frequency waitlist when a maximum frequency measurement list size meets or exceeds a maximum frequency measurement list size threshold value, wherein the second portion of the set of frequencies includes a second sequence of one or more frequencies. The processor is further configured to execute the instructions to perform a communication procedure based on one or more frequencies stored in one or both of the frequency measurement list and the frequency waitlist.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a user equipment that may perform one or more measurements;

FIG. 2 is a conceptual diagram of an example frequency measurement list and waitlist updating scheme, e.g., according to FIG. 1;

FIG. 3 is a flowchart of an aspect of a method of wireless communication, e.g., according to FIG. 1;

FIG. 4 is a flowchart of another aspect of a method of communication, e.g., according to FIG. 1;

FIG. 5 is a flowchart of a further aspect of a method of communication, e.g., according to FIGS. 1 and 4;

FIG. 6 is a block diagram illustrating an example of a hardware implementation for an apparatus employing a processing system, e.g., according to FIG. 1;

FIG. 7 is a block diagram conceptually illustrating an example of a telecommunications system, including at least an aspect of the user equipment described herein;

FIG. 8 is a conceptual diagram illustrating an example of an access network, e.g., according to FIG. 1;

FIG. 9 is a conceptual diagram illustrating an example of a radio protocol architecture for the user and control plane that may be utilized by the user equipment described herein; and

FIG. 10 is a block diagram conceptually illustrating an example of a Node B in communication with a UE in a telecommunications system, where the user equipment may be the same as or similar to the user equipment described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present aspects generally relate to improved methods and apparatus for storing and managing frequencies at a user equipment (UE) received from a network entity. In some aspects, the frequencies may be used for cell reselection/handover/redirection. Specifically, a UE may receive one or more messages from a network entity specifying a number of frequencies that may be used to search for cells. For example, the searches are intended to identify an ideal target cell for reselection, handover or redirection based on the target cell's communication characteristics (e.g., signal strength, cell energy and/or cell power). In other words, using the received frequencies, the UE may engage in one or more searches corresponding to each frequency to locate a target cell, or in other aspects, one or more suitable cells.

The target cell may, for instance, exhibit higher communication quality based on one or more characteristics such as, but not limited to quality of service relative to the other searched cells or to the currently camped cell. However, due to hardware and/or software constraints, the UE may be unable to search all of the frequencies received from the network entity until, for example, a subsequent message including one or more additional frequencies are received. For instance, such hardware and/or software constraints may limit the number of frequencies which may be stored and/or searched. As such, the UE may be unable to search frequencies that may nonetheless be strong reselection/handover/redirection candidates. As a result, the UE may not search for and thereby reselect, handover, or redirect to the most optimum cell due to the aforementioned deficiencies. Accordingly, in some aspects, the present methods and apparatuses may provide an efficient solution, as compared to current solutions, to perform frequency measurement management using a frequency waitlist for enhanced cell handover/reselections/redirection.

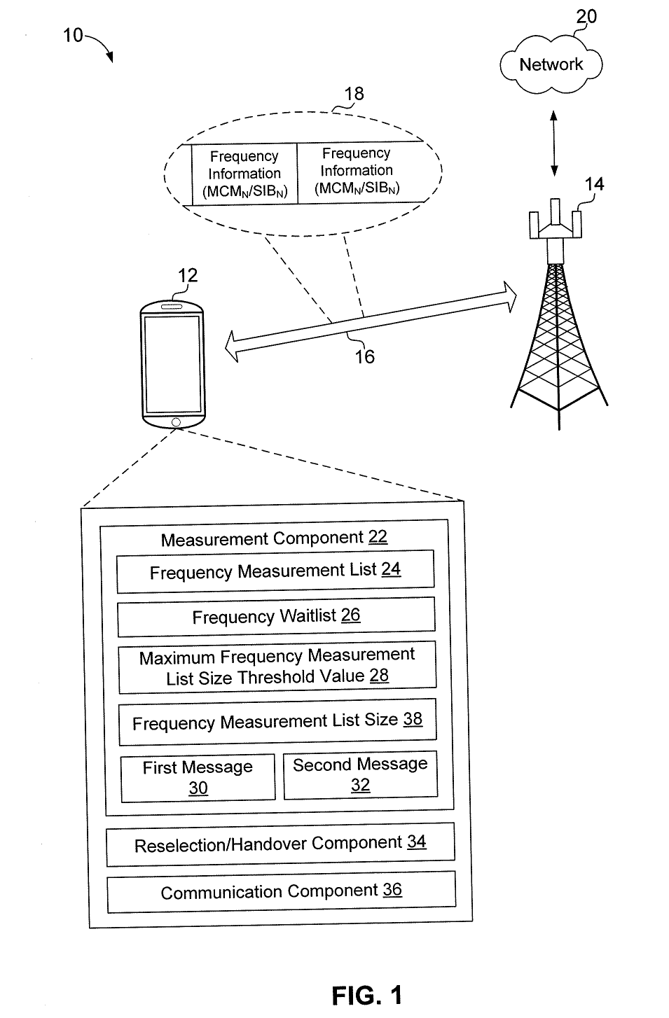

Referring to FIG. 1, in an aspect, a wireless communication system 10 includes at least one UE 12 in communication coverage of at least one network entity 14 (e.g., base station). UE 12 may communicate with network 20 via network entity 14. In some aspects, multiple UEs including UE 12 may be in communication coverage with one or more network entities, including network entity 14. In an example, UE 12 may transmit and/or receive wireless communications 16 to and/or from network entity 14. Such wireless communications 16 may include, but are not limited to, frequency information 18. In such aspect, UE 12 may receive frequency information 18 from network entity 14, which may also be considered the serving cell for UE 12. In some aspects, frequency information 18 may be contained within or include information in the form of one or more measurement control messages (MCM) and/or one or more system information blocks (SIB) including cell (e.g., network entity 14) and/or network 20 specific parameters that are broadcast to permit UEs (e.g., UE 12) to communicate with a network (e.g., network entity 14 and/or network 20).

In such aspects, frequency information 18 may include or be represented as one or more evolved UMTS terrestrial access (EUTRA) absolute radio frequency channel numbers (EARFCN). Further, frequency information 18 may be signaled or communicated to UE 12 while in compressed mode (e.g., WCDMA), idle mode, FACH, or active/connected mode (e.g., DCH). For example, in idle mode, UE 12 may tune radio frequency resources to frequencies of the same or other technology types to perform searches. Further, for instance, in FACH mode, UE 12 may perform inter-frequency and inter-radio access technology (RAT) searches even when measurements from the searches are not scheduled or due. UE 12 may perform the FACH searches based on, for instance, the FACH measurement occasion (FMO). Moreover, in the active/connected mode, network 20 may instruct UE 12 to enter into compressed mode when, for example, the serving frequency's quality declines below a threshold. As such, in compressed mode, UE 12 may search on the same or other frequencies (e.g., intra-frequency and/or inter-frequency) and technologies while maintaining an active connection/communication on the serving frequency.

Additionally, network entity 14 may support one or more frequencies of a particular technology type. For instance, in a non-limiting case, UE 12 may be capable of communicating with network entities, such as network entity 14 supporting overlay technologies (e.g., Long Term Evolution) or alternatively, when such communications are not suitable or are insufficient, with wideband technologies (e.g., WCDMA). Further, in such case, reselection among cells and/or associated frequencies may be based on frequency information (e.g., frequency information 18) received from network entities (e.g., network entity 14).

However, in some cases, frequency information 18 received from network entity 14 may not be optimally utilized for searching purposes (e.g., optimal frequency utilization), which may result in inferior cell reselections. Specifically, some frequency measurements 18 received from network entity 14 may be discarded as a result of hardware and/or software limitations with respect to searching capabilities (e.g., active frequency measurement limit). As such, UE 12 may include various components and/or subcomponents to provide more comprehensive frequency measurement management of the frequency information 18. For instance, rather than discarding a portion of the frequency information 18 which may not be used for active frequency searches, UE 12 may nonetheless store or maintain the unused frequency information so as to potentially reselect to the strongest or most preferable cell.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. Additionally, network entity 14 may be a macrocell, small cell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, UE 12 may include measurement component 22, which may be configured to manage frequency information 18 for enhanced cell reselection/handover/redirection. In such aspects, measurement component 22 may receive or otherwise obtain frequency information 18 (e.g., one or more frequencies in the form of EARFCNs) contained within or otherwise included in an MCM or SIB for the purpose of facilitating frequency searching in one or more modes (e.g., active, idle, FACH, compressed), and for subsequent cell handover/reselection/redirection. Further, in an aspect of the compressed mode, network 20, via network entity 14, may transmit or communicate any number of frequencies (e.g., frequency information 18 may include three neighbor frequencies) to conduct one or more searches on.

However, UE 12 may select only a number of those frequencies (e.g., initial two of three neighbor frequencies) to conduct the search. In some aspects, a first message 30 (e.g., MCM₁) may be received containing or including one or more frequencies. The frequencies may include, but are not limited to, one or any combination of frequency division duplexing (FDD) EARFCNs and time division duplexing (TDD) EARFCNs. In addition, measurement component 22 may be configured to store, based on a maximum frequency measurement list size threshold value 28, the one or more frequencies in one or both of a frequency measurement list 24 and frequency waitlist 26. In some aspects, one or both of frequency measurement list 24 and frequency waitlist 26 may be implemented in a stack arrangement within measurement component 22.

In an aspect, measurement component 22 may be configured to analyze or otherwise determine the total number and technology type of frequencies contained in the first message 30. As a non-limiting example, first message may include eight EARFCNs or the FDD or TDD type. Accordingly, based on the maximum frequency measurement list size threshold value 28, only a portion of the eight TDD EARFCNs may be stored in the frequency measurement list 24 (e.g., maximum frequency measurement list size threshold permits four). However, rather than discarding the remaining portion of the EARFCNs that cannot be stored on the frequency measurement list 24, the present aspects include a frequency waitlist 26, which may be configured to receive or otherwise store the remaining/unused portion of EARFCNs contained in the first message.

Moreover, by storing the remaining/unused portion of EARFCNs in a frequency waitlist, UE 12 may potentially locate or detect stronger reselection/handover/redirection candidates. Additionally, measurement component 22 may be configured to store a bandwidth value associated with each EARFCN and a blacklist cell information in one or both of the frequency measurement list 24 and the frequency waitlist 26. In some aspects, the blacklist cell information may include one or more prohibited frequencies (e.g., EARFCNs) which UE 12 may not be permitted to perform any type of communication procedure thereon.

Further, measurement component 22 may be configured to store the first sequence of frequencies forming the first portion up to the maximum frequency measurement list size threshold value 28. For instance, maximum frequency measurement list size threshold value 28 may be based in part on the hardware and/or software measurement limitations of UE 12. In a non-limiting example, the hardware and/or software measurement limitations may only permit a maximum of four FDD EARFCNs and four TDD EARFCNs. As such, the maximum frequency measurement list size threshold value 28 may be set to four. However, it should be understood that the maximum frequency measurement list size threshold value 28 may be set equal to one or both of the frequency measurement list size 38 or the hardware and/or software measurement limitations.

In such aspects, measurement component 22 may store a first portion (e.g., first four EARFCNs) from the set of frequencies in frequency measurement list 24. In some aspects, the frequency measurement list 24 represents or indicates the frequencies that UE 12 may search for at a given time. Accordingly, the remaining second portion may be stored in frequency waitlist 26, where the second portion of the set of frequencies includes a second sequence of one or more frequencies exceeding maximum frequency measurement list size threshold value 28.

In additional aspects, measurement component 22 may be configured to receive or otherwise obtain second message 32, containing a second set of frequencies from network entity 14, so as to update or modify one or both of the frequency measurement list 24 and the frequency waitlist 26. For example, second message 32 may include one or both of an add instruction and remove instruction corresponding to one or more frequencies. In some aspects, the add instruction and the remove instruction instruct UE 12 (e.g., via measurement component 22) to update/configure the set of frequencies stored in one or both of the frequency measurement list 24 and frequency waitlist 26. Specifically, for example, measurement component 22 may determine, based in part on the frequency measurement list size 38 and the maximum frequency measurement list size threshold value 28, whether an add instruction and/or a remove instruction would require an update or modification of one or both of the frequency measurement list 24 and frequency waitlist 26.

In some aspects, measurement component 22 may be configured to add one or more frequencies from the second set of frequencies to the frequency measurement list 24 based on the add instruction of the second message 32. Further, in such aspects, if a frequency measurement list size 38 is greater than the maximum frequency measurement list size threshold value 28, the measurement component 22 may be configured to transfer and/or sequentially transfer at least one frequency from the frequency measurement list 24 to the frequency waitlist 26. Moreover, measurement component 22 may transfer one or more frequencies to the frequency waitlist 26 until the frequency measurement list size 38 equals the maximum frequency measurement list size threshold value 28.

Further, measurement component 22 may be configured to remove one or more frequencies from the frequency measurement list 24 based on the remove instruction of the second message 32. Further, in such aspects, if a frequency measurement list size 38 is less than the maximum frequency measurement list size threshold value 28, the measurement component 22 may be configured to transfer at least one frequency from the frequency waitlist 26 to the frequency measurement list 24. Moreover, measurement component 22 may transfer and/or sequentially transfer at least one frequency from the frequency waitlist 26 until the frequency measurement list size 38 equals the maximum frequency measurement list size threshold value 28. In other aspects, the remove instruction may instruct measurement component 22 to remove one or more frequencies from the frequency waitlist 26.

In additional aspects, when an initial first portion and second portion are stored in the frequency measurement list 24 and the frequency waitlist 26 based on the first message 30, measurement component 22 may prioritize the one or more frequencies contained in subsequent message (e.g., second message 32) relative to frequencies in the frequency waitlist 26. In other words, when second message includes both an add instruction and a remove instruction, measurement component 22 may first remove the one or more identified frequencies from the frequency measurement list 24. Thereafter, measurement component 22 may be configured to add one or more frequencies corresponding to the add instruction of the second message 32.

However, only upon determining that additional space or slots remain in the frequency measurement list 24 (e.g., frequency measurement list size 38 is less than maximum frequency measurement list size threshold value 28), may measurement component 22 transfer one or more frequencies (e.g., in sequential order starting from the highest ordered or according to one or more frequency transfer rules) from the frequency waitlist 26 to the frequency measurement list 24. Hence, according to such aspects, the one or more frequencies corresponding to the add instruction in the frequency measurement list 24 sequentially precede the one or more frequencies transferred from the frequency waitlist 26.

In an aspect, measurement component 22 may be configured to transfer at least one frequency according to one or more frequency transfer rules. For example, the frequency transfer rules may include sequentially transferring one or more sequenced frequencies beginning with the lowest sequenced frequency from the frequency measurement list 24 to the frequency waitlist 26 when a frequency measurement list size 38 is greater than the maximum frequency measurement list size threshold value 28. In another example, the frequency transfer rules may include sequentially transferring one or more sequenced frequencies beginning with the highest sequenced frequency from the frequency waitlist 26 to the frequency measurement list 24 when a frequency measurement list size 38 is less than the maximum frequency measurement list size threshold value 28. Further aspects of the frequency transfer rules may include a reordering and/or sorting of the frequencies stored in one or both of the frequency measurement list 24 and the frequency waitlist 26 based on, for instance, historical service information of each frequency, band preference, received signal strength indication (RSSI), and priority level values for each frequency (EARFCN). Additionally, it should be understood that the foregoing are non-limiting examples of sortation criteria.

Moreover, in an aspect, UE 12 may include reselection/handover component 34, which may be configured to conduct cell reselection/handover/redirection based on the one or more frequencies (e.g., EARFCN) stored in the frequency measurement list 24. For instance, reselection/handover component 34 may obtain or otherwise receive the first portion of the set of frequencies in the frequency measurement list 24, or the updated portion in the frequency measurement list 24 (e.g., FDD EARFCNs, TDD EARFCNs), so as to reselect/handover/redirection to a cell having optimum communication characteristics. Further, in some aspects, reselection/handover component 34 may include a measurement component. Additionally, reselection/handover component 34 may alternatively be referred to as the handover component and/or the redirection component.

In additional aspects, UE 12 may include communication component 36, which may be configured to transmit and receive wireless communication 16 with one or more network entities (e.g., network entity 14). For example, in an aspect, the communication component 36 may receive frequency information 18 from one or more network entities (e.g., network entity 14). Further, communication component 36 may include, but is not limited to, one or more of a transmitter, a receiver, a transceiver, protocol stacks, transmit chain components, and receive chain components.

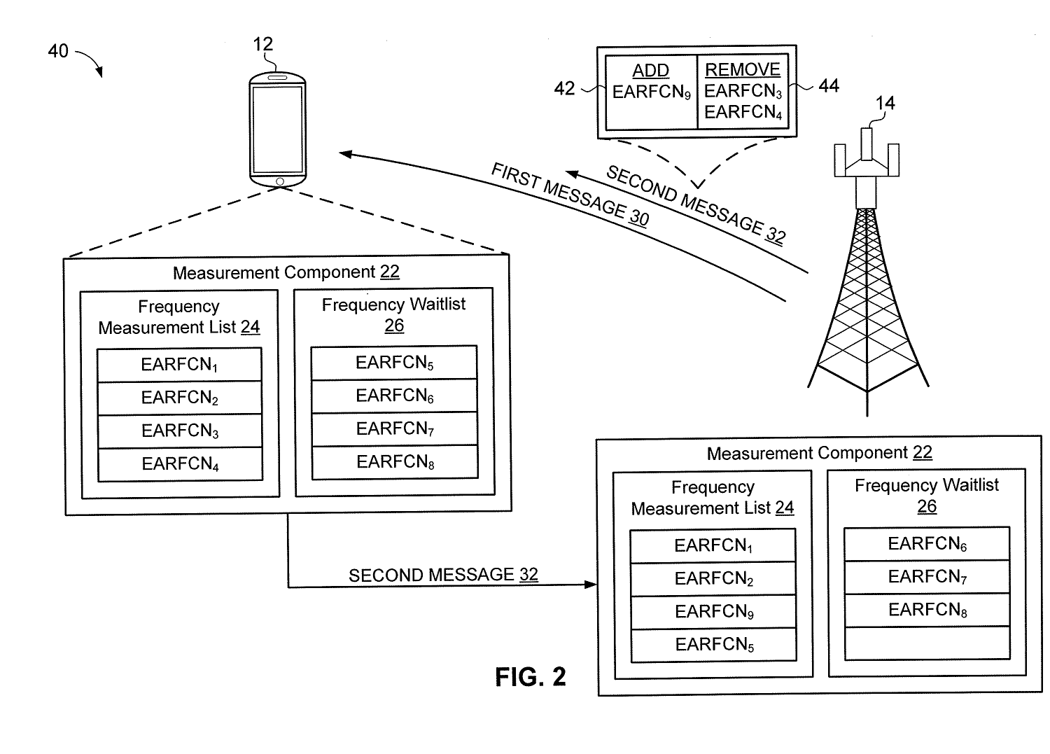

Referring to FIG. 2, in an aspect, an example measurement management scheme 40 includes UE 12 in communication with and configured to receive one or more messages from network entity 14. For example, UE 12 may receive first message 30 and subsequently second message 32. In such aspects, first message 30 may first configure UE 12, and in particular frequency measurement list 24 and frequency waitlist 26 with the initial set of frequencies during, for example, provisioning of UE 12 upon power up. Further, prior to receiving first message 30, frequency measurement list 24 and/or frequency waitlist 26 may not contain any frequency information. In some aspects, and as illustrated in FIG. 2, one or both of frequency measurement list 24 and frequency waitlist 26 may be implemented in a stack arrangement within measurement component 22.

Nonetheless, when UE 12 (e.g., via communication component 36) receives first message 30, it may provide first message 30 containing a set of frequencies (e.g., EARFCN₁₋₈) to measurement component 22. Measurement component 22 may then process or analyze the frequency information contained in the first message according to the features described herein. For instance, measurement component 22 may store a first portion (e.g., EARFCN₁₋₄) of the set of frequencies contained in the first message 30 in the frequency measurement list 24, according to the maximum frequency measurement list size threshold value 28 (FIG. 1). In the aspect shown in FIG. 2, the maximum frequency measurement list size threshold value 28 is equal to four. Moreover, the remaining portion (e.g., EARFCN₅₋₈) of the set of frequencies from the first message is stored in the frequency waitlist.

In some aspects, UE 12 may receive second message 32 from network entity 14. In such non-limiting aspects, second message 32 may include both an add instruction 42 and a remove instruction 44. It should be understood that second message may include one or both of the add instruction and remove instruction. The add instruction 42 is associated with or corresponds to a frequency (e.g., EARFCN₉) that is to be added to the frequency measurement list 24. Further, the remove instruction 44 is configured to instruct measurement component 22 to remove a plurality of frequencies (e.g., EARFCN₃ and EARFCN₄). Upon receiving and processing second message, measurement component 22 may update or otherwise modify the frequency measurement list 24 and the frequency waitlist 26 based on the instructions. As such, frequency waitlist 26 provides enhanced storage capabilities for storing valuable frequency information that would otherwise be discarded due to storage and/or hardware/software deficiencies/limitations.

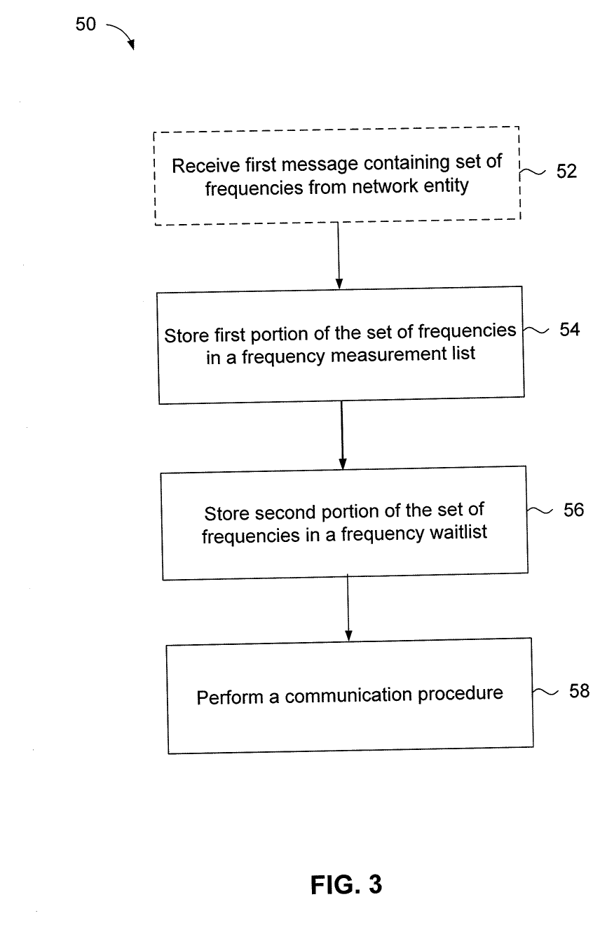

Referring to FIGS. 3-5, the methods are shown and described as a series of acts for purposes of simplicity of explanation. However, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

Referring to FIG. 3, in an operational aspect, a UE such as UE 12 (FIG. 1) may perform one aspect of method 50 for managing frequency measurements. In an aspect, at block 52, method 50 may optionally receive a first message at a UE including a set of frequencies from a network entity. For example, as described herein, UE 12 (FIG. 1) may execute measurement component 22 to receive first message 30 from network entity 14. In some aspects, UE 12 may execute communication component 36 to facilitate communication between measurement component 22 and network entity 14.

At block 54, method 50 may store a first portion of the set of frequencies in a frequency measurement list. For instance, as described herein, UE 12 (FIG. 1) may execute measurement component 22 to store a first portion of the set of frequencies in the frequency measurement list 24. Further, in some aspects, the first portion of the set of frequencies includes a first sequence of one or more frequencies.

Moreover, at block 56, method 50 may store a second portion of the set of frequencies in a frequency waitlist. For instance, as described herein, UE 12 (FIG. 1) may execute measurement component 22 to store a second portion of the set of frequencies in frequency waitlist 26. Further, in some aspects, the second portion of the set of frequencies includes a second sequence of one or more frequencies exceeding maximum frequency measurement list size threshold value 28.

Further, at block 58, method 50 may perform a communication procedure. For example, as described herein, measurement component 22 (FIG. 1) may execute reselection/handover component 34 to perform a communication procedure (e.g., search) based on the one or more frequencies stored in one or both of the frequency measurement list 24 and the frequency waitlist 26.

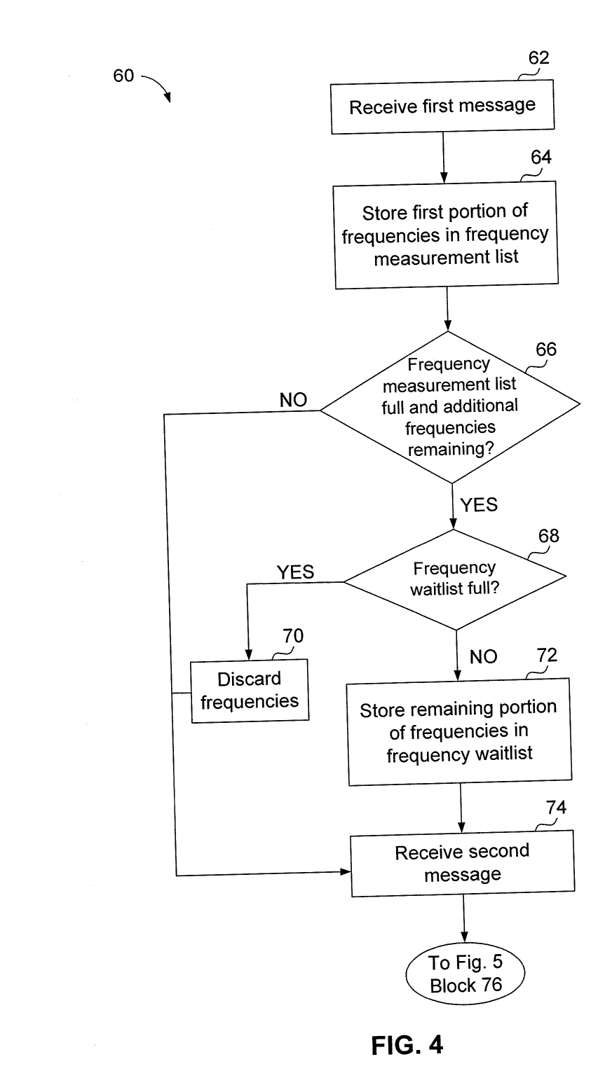

Referring to FIG. 4, in an operational aspect, a UE such as UE 12 (FIG. 1) may perform one aspect of method 60 for managing frequency measurements. In an aspect, at block 62, method 60 may receive a first message. For example, as described herein, UE 12 (FIG. 1) may execute measurement component 22 to receive a first message 30 including a set of frequencies from network entity 14. At block 64, method 60 may store a first portion of the frequencies in a frequency measurement list. For instance, as described herein, UE 12 (FIG. 1) may execute measurement component 22 to store a first portion of the set of frequencies in the frequency measurement list 24.

Further, at block 66, method 60 may determine whether additional frequencies are remaining and whether the frequency measurement list is full. For instance, as described herein, UE 12 (FIG. 1) may execute measurement component 22 to determine additional frequencies from the set of frequencies in the first message 30 are remaining and whether the frequency measurement list 24 is full. Method may proceed to block 74 when a determination is made that additional frequencies are not remaining. In particular, at block 66, method 60 may determine whether frequency measurement list size 38 meets or exceeds maximum frequency measurement list size threshold value 28 (FIG. 1). Otherwise, method 60 may proceed to block 68 when the frequency measurement list is full and additional frequencies received in the first message are remaining.

Specifically, at block 68, method 60 may determine whether the frequency waitlist is full. For example, as described herein, UE 12 (FIG. 1) may execute measurement component 22 to determine whether frequency waitlist 26 is full. In some aspects, at block 68, method 60 may determine whether a frequency waitlist size meets or exceeds a frequency waitlist list size threshold value. Method 60 may proceed to block 70 when the frequency waitlist is full and the frequencies are discarded. In other aspects, at block 70, method 60 may provide an error message at the UE and skip the addition of the one or more remaining frequencies to the frequency waitlist. Otherwise, method 60 may proceed to block 72 when the frequency waitlist is not full.

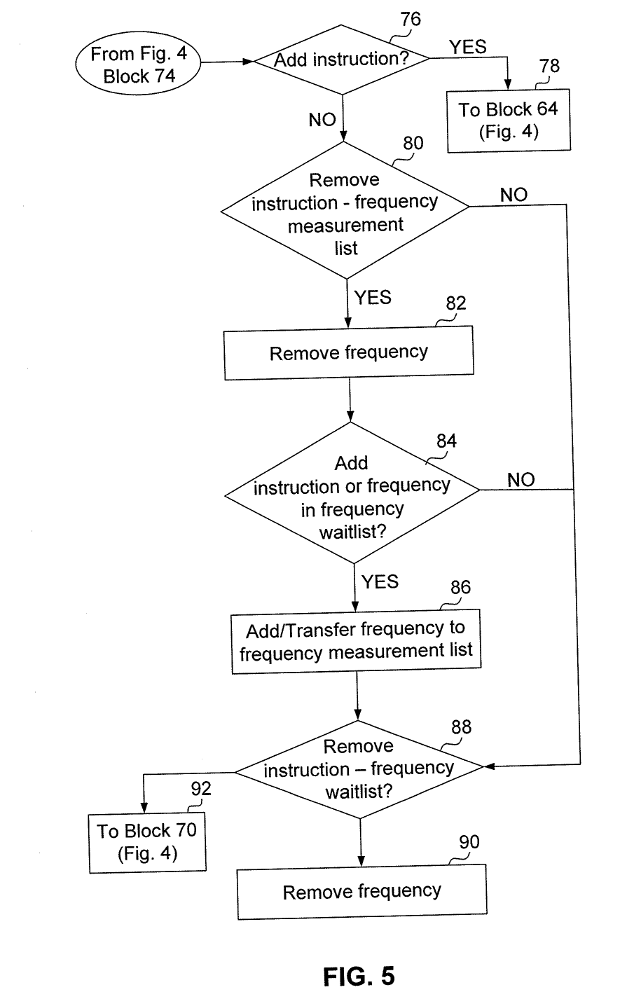

At block 72, method 60 may store the remaining portion of frequencies in the frequency waitlist. For instance, as described herein, UE 12 (FIG. 1) may execute measurement component 22 to store a second portion of the set of frequencies in frequency waitlist 26. Method 60 may proceed to block 74, where a second message is received from a network entity. For example, as described herein, UE 12 (FIG. 1) may execute measurement component 22 to receive second message 32 including a second set of frequencies from network entity 14. Method 60 may continue to block 76 in FIG. 5.

Referring to FIG. 5, in a further operational aspect, method 60 may continue from block 74 in FIG. 4. At block 76, method 60 may determine whether the second message includes an add instruction. For example, as described herein, UE 12 (FIG. 1) may execute measurement component 22 to determine whether second message 32 includes an add instruction to add one or more frequencies from the set of frequencies. Method 60 may proceed to block 78 when a determination is made that second message includes an add instruction. Specifically, in such aspect, method 60 may proceed to block 64 when a determination is made that second message includes an add instruction.

Otherwise, method 60 may proceed to block 80, where a determination is made whether a remove instruction is received to remove one or more frequencies from the frequency measurement list. For example, as described herein, UE 12 (FIG. 1) may execute measurement component 22 to determine whether a remove instruction is received to remove one or more frequencies from the frequency measurement list 24. Method 60 may proceed to block 88 when a determination is made that such a remove instruction is not received. Otherwise, method 60 may proceed to block 82, where one or more frequencies may be removed from the frequency measurement list based on the remove instruction. For instance, as described herein, UE 12 (FIG. 1) may execute measurement component 22 to remove one or more frequencies from the frequency measurement list 24.

Further, at block 84, method 60 may determine whether an add instruction has yet to be executed or one or more frequencies are present in the frequency waitlist. For instance, as described herein, UE 12 (FIG. 1) may execute measurement component 22 to determine whether an add instruction has yet to be executed or one or more frequencies are present in the frequency waitlist. Method 60 may proceed to block 88 when no add instruction is pending and one or more frequencies are not present in the frequency waitlist.

Otherwise, at block 86, method 60 may add one or more frequencies based on the add instruction and/or transfer one or more frequencies from the frequency waitlist to the frequency measurement list. In such aspect, it should be understood that such an addition or transfer to the frequency measurement list may be done so until the frequency measurement list meets or exceeds the maximum frequency measurement list size threshold value. For example, as described herein, UE 12 (FIG. 1) may execute measurement component 22 to add one or more frequencies based on the add instruction and/or transfer one or more frequencies from the frequency waitlist 26 to the frequency measurement list 24.

At block 88, method 60 may determine whether a remove instruction is received to remove one or more frequencies from the frequency waitlist. For instance, as described herein, UE 12 (FIG. 1) may execute measurement component 22 to determine whether a remove instruction is received to remove one or more frequencies from the frequency waitlist 26. Method 60 may proceed to block 92 when such a remove instruction is not received. Otherwise, at block 90, method 60 may remove the one or more frequencies specified by the remove instruction from the frequency waitlist. For instance, as described herein, UE 12 (FIG. 1) may execute measurement component 22 to remove one or more frequencies from the frequency waitlist 26.

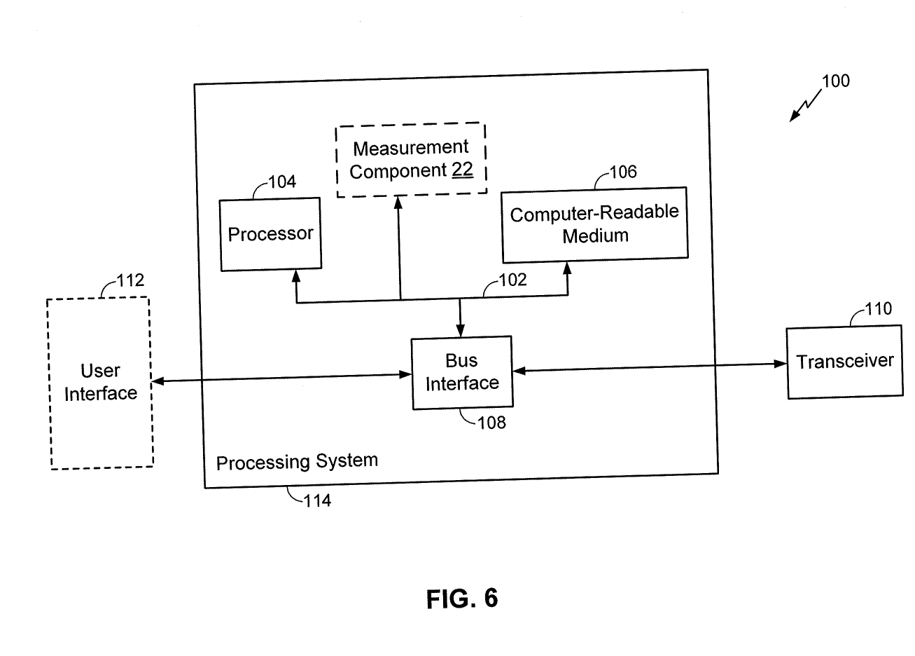

FIG. 6 is a block diagram illustrating an example of a hardware implementation for an apparatus 100 employing a processing system 114, wherein the apparatus may be the same as or similar to UE 12 executing at least measurement component 22 (FIG. 1). In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106, and UE components (e.g., UE 12), such as measurement component 22.

The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

Further, measurement component 22 (FIG. 1) may be implemented by any one or more of processor 104 and computer-readable medium 106. For example, the processor and/or computer-readable medium 106 may be configured to, via measurement component 22, to receive and store frequency information in a wireless communications device (e.g., UE 12).

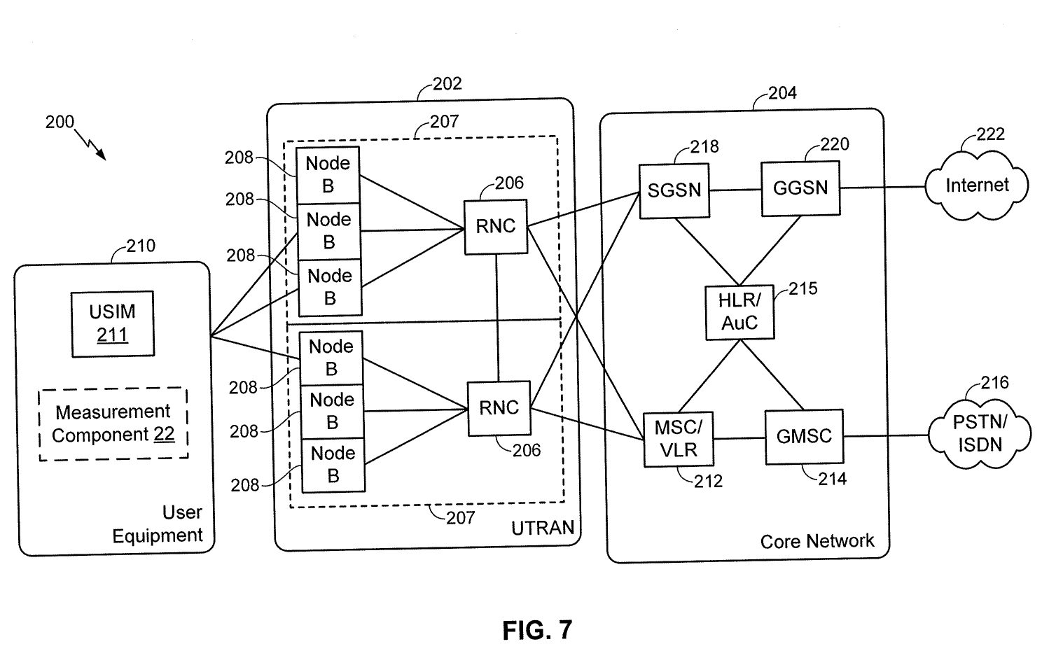

The various concepts presented throughout this disclosure may be implemented across a broad variety of telecommunication systems, network architectures, and communication standards. By way of example and without limitation, the aspects of the present disclosure illustrated in FIG. 7 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210 that may be the same as or similar to UE 12 including measurement component 22 (FIG. 1). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses.

Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

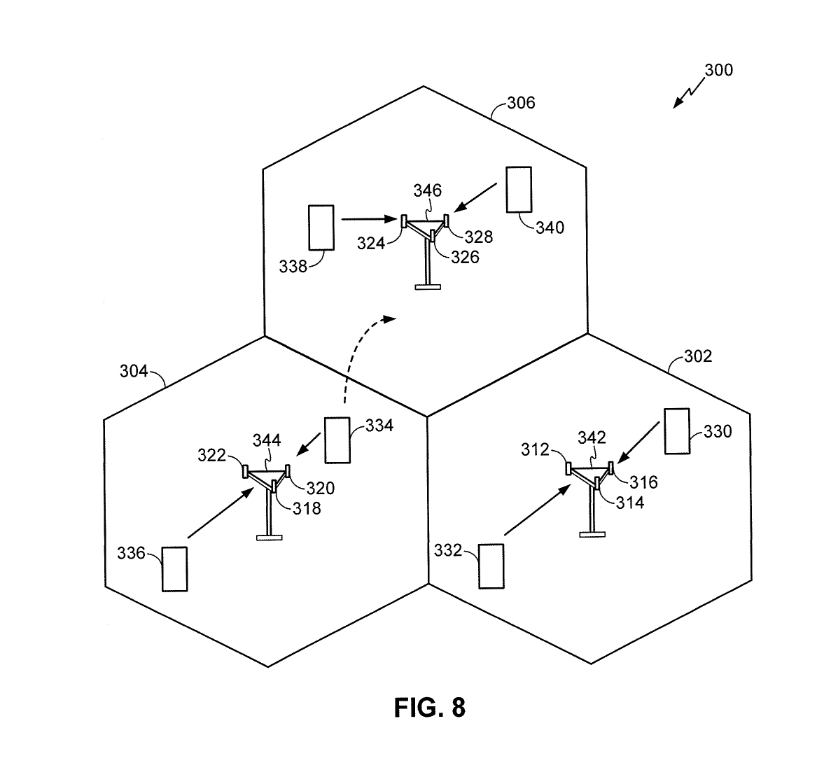

Referring to FIG. 8, an access network 300 in a UTRAN architecture is illustrated in which a UE, such as a UE the same as or similar to UE 12 (FIG. 1) may operate. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 2) for all the UEs 330, 332, 334, 336, 338, 340 in the respective cells 302, 304, and 306. In an aspect, the UEs 330, 332, 334, 336, 338 and/or 340 may include measurement component 22 (FIG. 1).

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 5), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented with reference to FIG. 7.

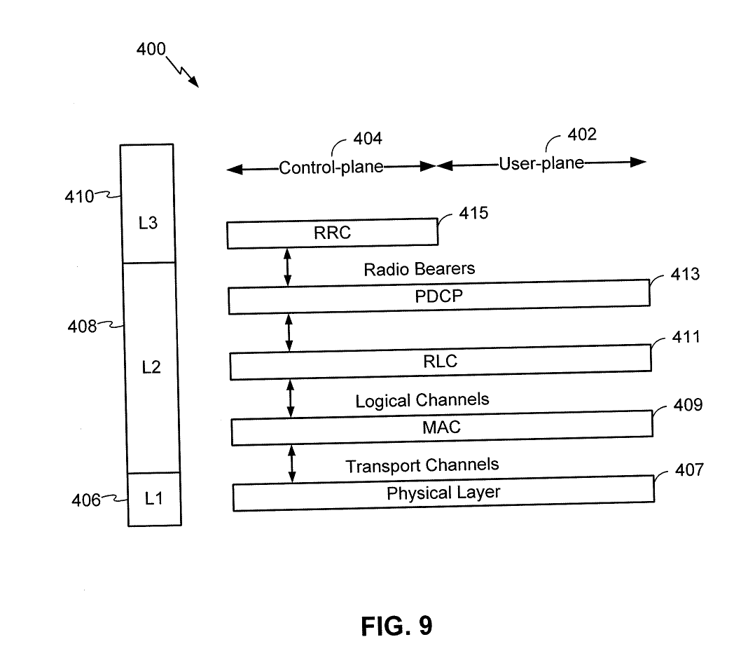

Referring to FIG. 9, an example radio protocol architecture 400 relates to the user plane 402 and the control plane 404 of a user equipment (UE) or node B/base station. For example, architecture 400 may be included in a UE such as UE 12 including measurement component 22 (FIG. 1). The radio protocol architecture 400 for the UE and node B is shown with three layers: Layer 1 406, Layer 2 408, and Layer 3 410. Layer 1 406 is the lowest lower and implements various physical layer signal processing functions. As such, Layer 1 406 includes the physical layer 407. Layer 2 (L2 layer) 408 is above the physical layer 407 and is responsible for the link between the UE and node B over the physical layer 407. Layer 3 (L3 layer) 410 includes a radio resource control (RRC) sublayer 415. The RRC sublayer 415 handles the control plane signaling of Layer 3 between the UE and the UTRAN.

In the user plane, the L2 layer 408 includes a media access control (MAC) sublayer 409, a radio link control (RLC) sublayer 411, and a packet data convergence protocol (PDCP) 413 sublayer, which are terminated at the node B on the network side. Although not shown, the UE may have several upper layers above the L2 layer 408 including a network layer (e.g., IP layer) that is terminated at a PDN gateway on the network side, and an application layer that is terminated at the other end of the connection (e.g., far end UE, server, etc.).

The PDCP sublayer 413 provides multiplexing between different radio bearers and logical channels. The PDCP sublayer 413 also provides header compression for upper layer data packets to reduce radio transmission overhead, security by ciphering the data packets, and handover support for UEs between node Bs. The RLC sublayer 411 provides segmentation and reassembly of upper layer data packets, retransmission of lost data packets, and reordering of data packets to compensate for out-of-order reception due to hybrid automatic repeat request (HARQ). The MAC sublayer 409 provides multiplexing between logical and transport channels. The MAC sublayer 409 is also responsible for allocating the various radio resources (e.g., resource blocks) in one cell among the UEs. The MAC sublayer 409 is also responsible for HARQ operations.

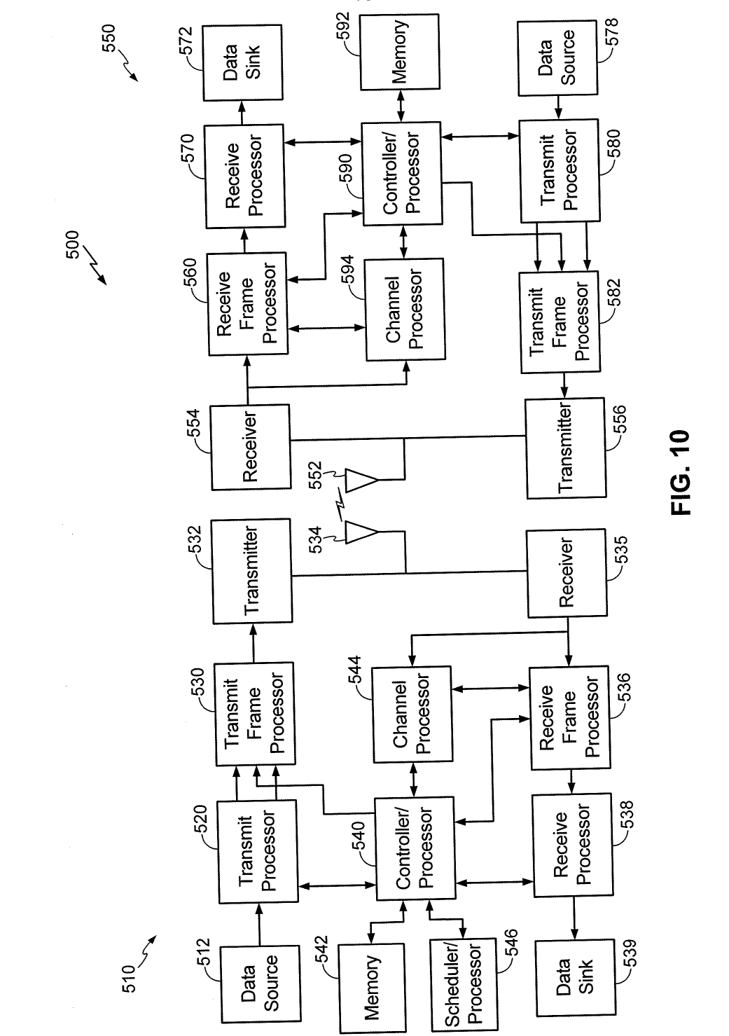

FIG. 10 is a block diagram of a Node B 510 in communication with a UE 550, where the Node B 510 may be the Node B 208 in FIG. 2, and the UE 550 may be the UE 210 in FIG. 5 or the UE 12 including measurement component 22 in FIG. 1. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 550 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 550, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 550, respectively. A scheduler/processor 546 at the Node B 510 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

What is claimed is:

1. A method of communication, comprising:
storing a first portion of a set of frequencies in a frequency measurement list, wherein the first portion of the set of frequencies includes a first sequence of one or more frequencies;
storing a second portion of the set of frequencies in a frequency waitlist when a maximum frequency measurement list size meets or exceeds a maximum frequency measurement list size threshold value, wherein the second portion of the set of frequencies includes a second sequence of one or more frequencies; and
performing a communication procedure based on one or more frequencies stored in one or both of the frequency measurement list and the frequency waitlist.

2. The method of claim 1, further comprising receiving a message containing a second set of frequencies from a network entity, wherein the message comprises one or both of an add instruction and a remove instruction corresponding to one or more frequencies of the second set of frequencies.

3. The method of claim 2, wherein the add instruction instructs a user equipment (UE) to add one or more frequencies from the second set of frequencies to the frequency measurement list.

4. The method of claim 3, further comprising transferring at least one frequency from the frequency measurement list to the frequency waitlist when the maximum frequency measurement list size meets or exceeds the maximum frequency measurement list size threshold value.

5. The method of claim 2, wherein the remove instruction instructs a UE to remove one or more frequencies from the frequency measurement list.

6. The method of claim 5, further comprising transferring at least one frequency from the frequency waitlist to the frequency measurement list when the maximum frequency measurement list size is less than the maximum frequency measurement list size threshold value.

7. The method of claim 2, wherein the remove instruction instructs a UE to remove one or more frequencies from the frequency waitlist.

8. The method of claim 2, further comprising transferring at least one frequency from the frequency waitlist to the frequency measurement list when a frequency measurement list size following addition of one or more frequencies corresponding to the add instruction is less than the maximum frequency measurement list size threshold value.

9. The method of claim 8, wherein the one or more frequencies corresponding to the add instruction in the frequency measurement list sequentially precede the one or more frequencies transferred from the frequency waitlist.

10. The method of claim 2, wherein the set of frequencies and the second set of frequencies comprise one or both of a frequency division duplex E-UTRA absolute radio frequency channel number and a time division duplex E-UTRA absolute radio frequency channel number.

11. An apparatus for communication, comprising:
means for storing a first portion of a set of frequencies in a frequency measurement list, wherein the first portion of the set of frequencies includes a first sequence of one or more frequencies;
means for storing a second portion of the set of frequencies in a frequency waitlist when a maximum frequency measurement list size meets or exceeds a maximum frequency measurement list size threshold value, wherein the second portion of the set of frequencies includes a second sequence of one or more frequencies; and
performing a communication procedure based on one or more frequencies stored in one or both of the frequency measurement list and the frequency waitlist.

12. An apparatus for communication, comprising:
a memory storing executable instructions;
and a processor in communication with the memory, wherein the processor is configured to execute the instructions to:
store a first portion of a set of frequencies in a frequency measurement list, wherein the first portion of the set of frequencies includes a first sequence of one or more frequencies; and
store a second portion of the set of frequencies in a frequency waitlist when a maximum frequency measurement list size meets or exceeds a maximum frequency measurement list size threshold value, wherein the second portion of the set of frequencies includes a second sequence of one or more frequencies; and
perform a communication procedure based on one or more frequencies stored in one or both of the frequency measurement list and the frequency waitlist.

13. The apparatus of claim 12, wherein the processor is further configured to execute the instructions to receive a message containing a second set of frequencies from a network entity, wherein the message comprises one or both of an add instruction and a remove instruction corresponding to one or more frequencies of the second set of frequencies.

14. The apparatus of claim 13, wherein the add instruction instructs a user equipment (UE) to add one or more frequencies from the second set of frequencies to the frequency measurement list.

15. The apparatus of claim 14, wherein the processor is further configured to execute the instructions to transfer at least one frequency from the frequency measurement list to the frequency waitlist when the maximum frequency measurement list size meets or exceeds the maximum frequency measurement list size threshold value.

16. The apparatus of claim 13, wherein the remove instruction instructs a UE to remove one or more frequencies from the frequency measurement list.

17. The apparatus of claim 16, wherein the processor is further configured to execute the instructions to transfer at least one frequency from the frequency waitlist to the frequency measurement list when the maximum frequency measurement list size is less than the maximum frequency measurement list size threshold value.

18. The apparatus of claim 13, wherein the remove instruction instructs a UE to remove one or more frequencies from the frequency waitlist.

19. The apparatus of claim 13, wherein the processor is further configured to execute the instructions to transfer at least one frequency from the frequency waitlist to the frequency measurement list when a frequency measurement list size following addition of one or more frequencies corresponding to the add instruction is less than the maximum frequency measurement list size threshold value.

20. The apparatus of claim 19, wherein the one or more frequencies corresponding to the add instruction in the frequency measurement list sequentially precede the one or more frequencies transferred from the frequency waitlist.
